(19) United States
(12) Patent Application Publication
(10) Pub. No.: US 2003/0170526 A1
(43) Pub. Date: Sep. 11, 2003

(54) Substrate treatment

(75) Inventors: David R. Hodgson, Bolton (GB); Emma Farndon, Frodsham (GB)

Correspondence Address: PILLSBURY WINTHROP, LLP, P.O. BOX 10500, MCLEAN, VA, 22102, US

(73) Assignee: Ineos Chlor Limited, Runcorn (GB)

(21) Appl. No.: 10/357,424

(22) Filed: Feb. 4, 2003

Related U.S. Application Data
(63) Continuation-in-part of application No. PCT/GB01/03319, filed on Jul. 24, 2001.
(60) Provisional application No. 60/225,391, filed on Aug. 15, 2000.

(30) Foreign Application Priority Data
Aug. 5, 2000 (GB) 0019154.4
Feb. 13, 2002 (GB) 0203324.9

(51) Int. Cl. H01M 8/02; H01M 8/24

(52) U.S. Cl. 429/34; 29/623.1; 429/38

(57) ABSTRACT

Metal plates to be used in electrochemical cells, e.g. fuel cells, are treated by subjecting a surface or surfaces thereof to an electrical current in the presence of an acidic electrolyte, the alloy being stainless steel or one containing in excess of 14% by weight nickel, e.g. in excess of 15% by weight nickel.

This invention relates to the treatment of corrosion resistant metal alloy components to be incorporated in electrochemical cells. Although the invention will be described in the context of components for fuel cells, it is to be understood that the invention also finds application in other types of electrochemical cells, for example electrolytic cells as used for organic synthesis of chemicals and for production of chlorine, hydrogen or oxygen.

A fuel cell is an electrochemical device in which electricity is produced without combustion of fossil fuel. In a fuel cell a fuel, which is typically hydrogen, is oxidised at a fuel electrode (anode) and oxygen, typically from air, is reduced at a cathode to produce an electric current and form by-product water. An electrolyte is required which is in contact with both electrodes and which may be alkaline or acidic, liquid or solid. Heat and water are the only by-products of the electrochemical reaction in fuel cells wherein the fuel is hydrogen. Accordingly, the use of such cells in power generation offers potential environmental benefits compared with power generation from combustion of fossil fuels or by nuclear activity.

In proton-exchange membrane fuel cells, hereinafter referred to for convenience as “PEM” fuel cells, the electrolyte is a solid polymer membrane which allows transport of protons from the anode to the cathode and is typically based on perfluorosulphonic acid materials. The electrolyte must be maintained in a hydrated form during operation in order to prevent loss of ionic conduction through the electrolyte.

A PEM fuel cell typically comprises two electrodes, an anode and a cathode, separated by a proton-exchange membrane electrolyte. At the anode, hydrogen fuel catalytically dissociates into free electrons and protons. The free electrons are conducted in the form of usable electric current through the external circuit with which the fuel cell is in electrical contact. The protons migrate through the membrane electrolyte to the cathode where they combine with oxygen from the air and electrons from the external circuit to form water and generate heat. Individual fuel cells may be combined into assemblies which are often referred to in the art as stacks to provide the amount of power required.

Electrochemical cells, such as fuel cells, often incorporate stainless steel components where possible for reasons of economy. In a fuel cell stack for instance, separator plates between adjacent fuel cells and/or current collecting end plates may comprise stainless steel. In electrolytical cells as used for example in the generation of chlorine, electrodes or interconnecting plates of the cell may comprise stainless steel.

An important factor in securing good cell efficiency is the interfacial resistance between the surfaces of stainless steel substrates and the surfaces of other components to which the steel substrates are directly or indirectly electroconductively coupled.

While the use of metal plates in fuel cells is seen as having many advantages over other materials, there are concerns over the issue of corrosion which can lead to increased cell resistances. Makkus et al (J. Power Sources, 86 (2000) 274) for instance has reported that the anode side of the fuel cell (i.e. the hydrogen side) containing stainless bipolar plates, gives rise to a greater corrosion of the plate than the cathode (i.e. air) side. Makkus et al also refers to metal passivation resulting in increased resistance.

The present invention seeks to secure improvements in efficiency of operation of electrochemical cells, particularly fuel cells.

According to one aspect of the present invention there is provided a method of manufacturing an electrochemical cell assembly in which at least one component, e.g. a plate or a screen, which is exposed to the chemical environment during operation of the cell comprises a metal alloy which is a stainless steel or an alloy containing nickel in excess of that present in 316L stainless steel (typically in excess of 14% by weight, e.g. in excess of 15%) and incorporating the treated component in the cell assembly, said method comprising treating a surface of the alloy, prior to incorporation in the assembly, with an electrical current while contacted by an electrolyte.

The alloy may contain nickel and chromium. The nickel content may exceed the chromium content.

The alloy may be a stainless steel in which the nickel content is in excess of that of 316 or 316L stainless steel, e.g. 904, 904L or Carpenter 20 stainless steel.

The nickel content of the alloy may be at least 17% by weight, e.g. at least 18% by weight and may be even as much as 20% or more by weight.

The nickel may be the major component of the alloy. Thus, the alloy may be a nickel alloy such as Inconel or Incoloy, e.g. Inconel 600 or Inconel 825.

Usually the chromium content of the alloy, e.g. a stainless steel or a nickel alloy, will be at least 10.5% by weight, e.g. at least 12% by weight.

The alloy may contain at least 14% chromium and at least 20% nickel, e.g. at least 18% chromium and at least 24% nickel.

In some cases, the nickel content may be at least 60%.

The alloy may contain iron. Typically the alloy is one containing nickel, chromium and iron as the primary alloying components and the iron content may be higher or lower than the nickel and/or chromium content. The iron content may exceed the combined nickel and chromium content or the combined nickel and chromium content may exceed the iron content.

The treatment is typically carried out with the alloy as the anode (anodic treatment) using dc current.

A feature of the invention is that it is possible to use a relatively inexpensive alloy. We have surprisingly found that it is possible to reduce the interfacial resistance associated with such a stainless steel by a process which would normally be expected to increase it. Conventional wisdom leads to an expectation that subjecting a stainless steel surface to anodic treatment would normally result in the growth of oxides on the surface and hence result in an increased interfacial resistance.

In this specification, interfacial resistance is measured by the method as described herein below.

The method of the invention may also include the step of selecting the viscosity of the electrolyte in conjunction with other conditions to secure a reduction in the interfacial resistance associated with said surface.

Control of viscosity may be effected by the addition of a viscosity-enhancing agent but we do not exclude the possibility of controlling the concentration of the acid component of the electrolyte, particularly when the acid component is one, such as phosphoric acid, having significant viscosity compared with for example sulphuric acid.

The viscosity enhancing agent may be organic. Typically the viscosity enhancing agent is a polyol, e.g. a glycol such as polyethylene glycol, or a glycerol. The use of a viscosity enhancing agent has been found to be particularly advantageous when used in conjunction with an electrolyte containing sulphuric acid, e.g. an electrolyte in which sulphuric acid is the main or only acidic component present.

Reduction in interfacial resistance may be obtained by subjecting the stainless steel to an electrical potential or current of substantially constant or variable magnitude. For example, during at least major part of the treatment, the current density or applied voltage may be maintained substantially constant.

The treatment of the stainless steel surface may involve modification of the surface composition of the stainless steel and/or the surface morphology thereof.

In the case of a stainless steel, the treatment may be such that the ratio of iron content to the chromium within the surface region of the stainless steel is reduced compared with the iron to chromium ratio prevailing prior to such treatment; the reduction in the iron to chromium ratio may be to such an extent that prior to treatment the chromium content at the surface of the stainless steel is less than the iron content and in which following treatment the chromium content at the surface of the stainless steel exceeds the iron content.

Prior to such treatment, the surface or surfaces of the alloy may be roughened by physical techniques which are known in the art, e.g. by grit blasting.

The treatment may be applied to two or more surfaces of the alloy. The same treatment may be applied at least to each major surface of the alloy or the treatment applied to one surface of the alloy may be different from that applied to one or more other surfaces of the alloy.

The cell assembly may comprise two or more of said alloy components, e.g. plates, treated as aforesaid.

The assembly may include bipolar plates, separator plates, flow field plates and/or current collecting plates or screens, at least one of which comprises an alloy treated as aforesaid.

The acid(s) present in the electrolyte may be selected from one or more of the group comprising sulphuric acid, a halogenic acid such as hydrochloric acid, nitric acid, chromic acid, oxalic acid and phosphoric acid. The acid component or primary acid component of the electrolyte will usually be one which is non-halogenic, e.g. sulphuric acid.

The treatment may be carried out at ambient temperature (e.g. with the electrolyte initially at substantially room temperature). Nevertheless, we do not exclude the possibility of the treatment being carried out at elevated temperatures. Usually, however, the temperature at least initially will not be greater than about 100° C., typically not greater than about 90° C. and more usually not greater than about 70° C.

The electrolyte may typically have a pH of up to about 6 or less, e.g. less than 5.

The treatment may be such that the interfacial resistance of the alloy is reduced by a factor of at least 5%, preferably at least 10% and more preferably at least 15%, less than would otherwise prevail in the case of the untreated surface.

Typically said factor is at least 25%, e.g. at least 40% or even at least 50%, less than would otherwise prevail would otherwise prevail in the case of the untreated surface.

The so treated surface of the alloy may be coated with an electrically conductive material following treatment to reduce its interfacial resistance, e.g. with a coating of titanium nitride or chromium nitride or an electrocatalytically active material.

Examples of the electrocatalytical coating treatment that may be applied are disclosed in our prior International Patent Application No. WO 00/22689, the entire contents of which are where the context admits incorporated herein by this reference. For example, the electrocatalytically-active material may be selected from the group comprising: one or more platinum group metals or oxides thereof, cerium or an oxide thereof; ruthenium or an oxide thereof; ruthenium oxide and a non-noble metal oxide; mixtures of RuO₂ with at least one of TiO2, SnO₂, IrO₂, PtO, Sb₂O₃, Ta₂O₅, PdO, CeO₂, Co₃O₄.

The stainless steel is preferably an austenitic stainless steel.

The stainless steel may be a 300 series stainless steel such as 316 or 316L stainless steel.

The treatment may be carried out while the alloy is in the form of a sheet, the treated sheet subsequently being divided to form a number of plates for incorporation in one or more electrochemical cell assemblies.

Alternatively, the alloy may initially be in the form of a sheet which is then divided to form a number of plates before the treatment is applied to the individual plates.

Fluid flow channels may be formed in the sheet before such division into plates is effected. Alternatively the fluid flow channels may be formed after division has been effected.

The electrochemical cell may comprise a fuel cell, e.g. a PEM fuel cell, an alkaline fuel cell, a phosphoric acid fuel cell, a direct methanol fuel cell, a molten carbonate fuel cell or a solid oxide fuel cell.

According to another aspect of the present invention there is provided a fuel cell stack comprising: a) a plurality of fuel cell units each of which contains a proton-exchange membrane separating the cell into anolyte and catholyte chambers and provided with an anode and a cathode on opposite sides thereof; b) a separator plate, flow field plate or bipolar plate disposed between adjacent cell units; c) current-collecting means comprising a pair of plates located one at each end of the stack; d) means for feeding fuel, e.g. hydrogen or methanol, to the anolyte chambers of the stack; and e) means for feeding an oxygen-containing gas to the catholyte chambers of the stack; at least one of said plates being an alloy plate, e.g. a stainless steel such as 316 or 904 stainless steel plate or a nickel alloy such as Incoloy 825 or 020 or Inconel 600, a surface of which has been treated with an electrical current while contacted by an acidic electrolyte under conditions which reduce the interfacial resistance associated with said surface.

The invention will now be described further with reference to the accompanying drawings in which:

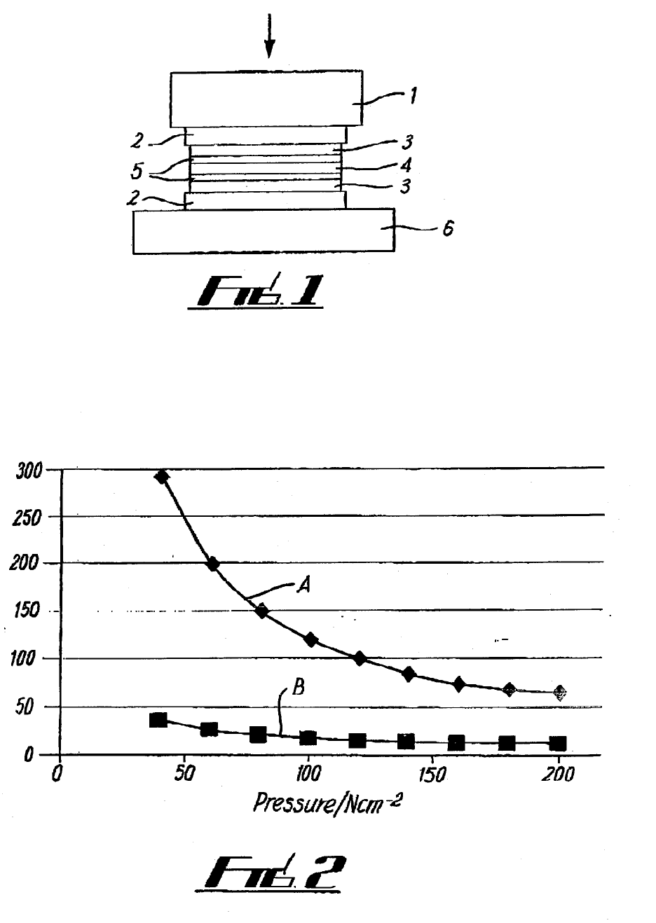

FIG. 1 illustrates schematically a system for measuring interfacial resistance;

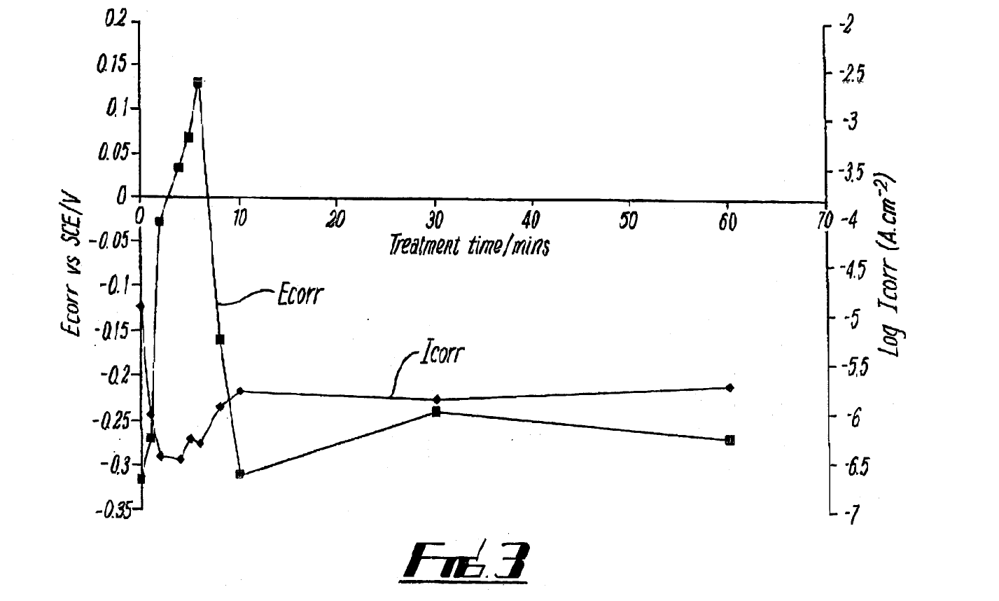

FIG. 2 is a graph illustrating the variation of interfacial resistance with loading, obtained using the system of FIG. 1, for treated and untreated samples of stainless steel;

FIG. 3 is a graphical representation of corrosion potential and corrosion current against treatment time for samples of stainless steel treated at the same current density;

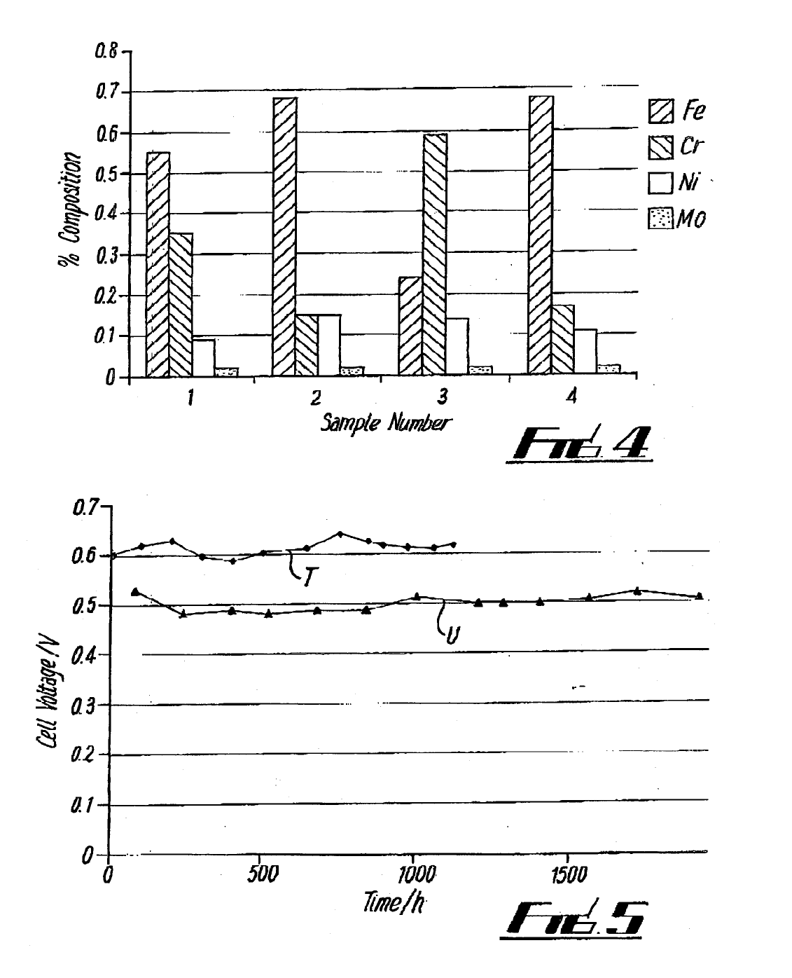

FIG. 4 is a graph illustrating the proportions of iron, chromium, nickel and molybdenum constituents present at the surface of an untreated specimen, an untreated and grit blasted specimen, a treated specimen treated in accordance with the invention and the bulk composition, all specimens being composed of the same 316 stainless steel;

FIG. 5 is a graphical representation comparing the long term operation of a single cell fuel cell provided with stainless steel plates treated in accordance with the present invention and a corresponding fuel cell provided with untreated plates of the stainless steel;

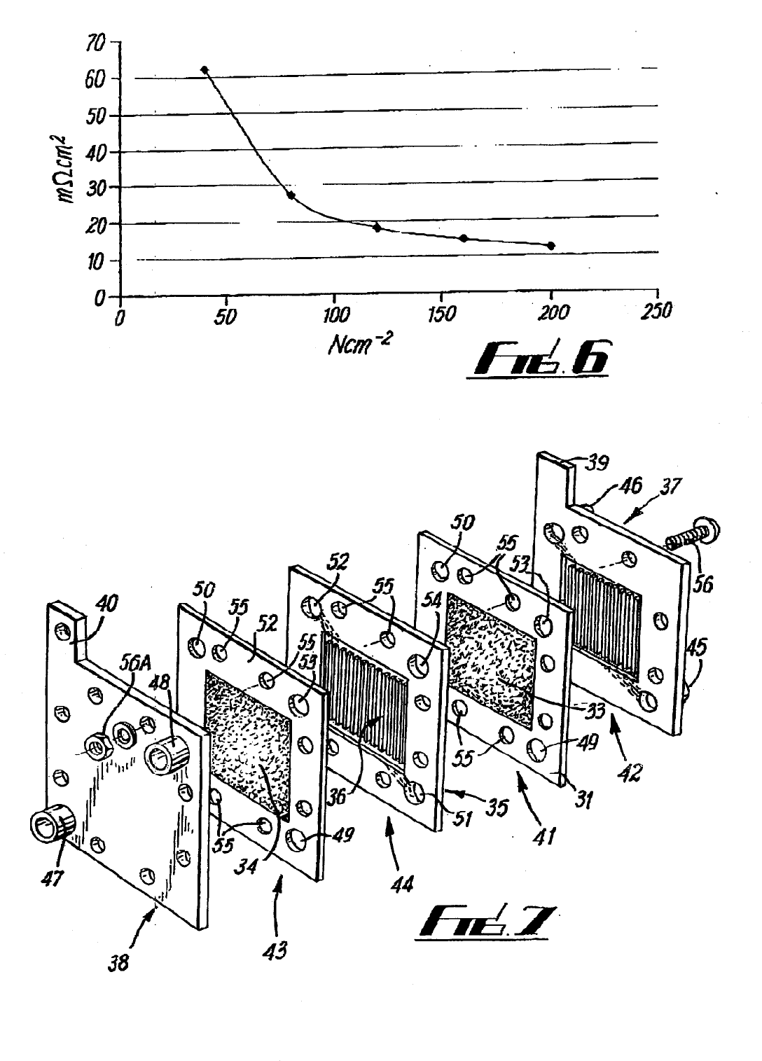

FIG. 6 is a graph illustrating the variation of interfacial resistance with loading, obtained using the system of FIG. 1, for a sample of stainless steel treated at constant voltage; and

FIG. 7 is a schematic exploded perspective view illustrating by way of example only a fuel cell stack of the ion exchange membrane type with only a limited number of cell units illustrated for simplicity, the stack incorporating alloy components which have been treated by a process in accordance with the present invention.

Interfacial resistance as referred to in this specification is measured using the measurement system illustrated in, and the following procedure described with reference to, FIG. 1.

Referring to FIG. 1, the system comprises of a tensometer (Lloyd Instruments LRX plus, AMETEK Inc.) which is shown in FIG. 1 as a fixed press plate 6 and a moveable press plate 1. The sample 4 of stainless steel or other nickel-containing alloy having an area of about 50×50 mm is sandwiched between two pieces of carbon diffuser 5 which may comprise for example carbon paper, made by Toray, or Carbel carbon cloth manufactured by W L Gore and Associates. This composite is then sandwiched between two gold plated copper plates 3 (50×50 mm) with the carbon diffuser layers in contact with the gold plated faces. The copper plates 3 have two sets of leads connected to them, one for use in measuring the voltage drop across the plates 3 and the second set for use in passing current through the system. A constant 5 Amps is applied using a Hewlett Packard HP 6008A DC power supply (not shown). The above assembly 3, 4, 5 is isolated from the tensometer itself using two blocks of insulating material 2, for example PTFE. Before the tensometer is operated to apply compressive forces to the assembly, the leads from the gold/copper plates are connected to a voltmeter (e.g. a FLUKE 73 III Multimeter, not shown), and to the Hewlett Packard power supply. The power supply is set to 5 Amps and an ammeter (Beckman Industrial T100B) is used to precisely measure the current.

Once the sample plate 4 has been prepared and assembled as described above, the tensometer is operated in stepwise fashion to apply increasing pressures ranging from 40 to 200 Ncm⁻². Voltage drops, E, are measured from the voltmeter each time the tensometer reaches a set value stored by the machine. Because this method records the voltage drop over two interfaces, only half the voltage drop is used to calculate the interfacial resistance, R_{I} using the formula:

R_{I}=(E/2×A)/I

where I is the applied current (5 Amps) and A is the area of overlap between the sample 4 and the carbon diffuser, (typically 25 cm²).

FIG. 2 represents a typical plot in which curve B represents the results obtained using a stainless steel plate sample which has been treated in accordance with the process of the invention. The anodic treatment in this instance involved a current density of 25 mA.cm⁻² for 30 minutes with the plate immersed in an aqueous electrolyte of 0.5M sulphuric acid, initially at room temperature. Curve A represents results obtained using the system and procedure described above in relation to FIG. 1 but with an untreated piece of the stainless steel. From FIG. 2, it will be seen that curves A and B approach values for R_{I} which remain substantially constant at pressures of the order of 200 Ncm⁻² and higher. As used in the specification, interfacial resistance corresponds to the value obtained at a loading of 200 Ncm⁻². It will be observed that the interfacial resistance for the treated sample is significantly less than that for the untreated sample, i.e. about 12 mΩcm² compared to about 65 mΩcm².

Typically plates of alloy to be treated for use in an electrochemical cell in accordance with the invention are subjected to the following treatment steps. The alloy workpiece is degreased using a suitable solvent (e.g. acetone, isopropyl alcohol, trichloroethylene, caustic agents etc.) and immersed in a bath of electrolyte. The electrolyte is acid based containing one or more of the following: sulphuric acid, hydrochloric acid, nitric acid, chromic acid, oxalic acid and phosphoric acid. Using appropriate counter electrodes (e.g. platinised Ti), a dc current is passed between the workpiece (as the anode) and the counter electrodes (as the cathode). This current is calculated as a current density and may be from 0.01 mA/cm² to 500 mA/cm², preferably in the range 1 to 50 mA/cm². The current is controlled at the required level for a time between 0.5 and 180 minutes, preferably between 1 and 60 minutes and more preferably between 2 and 7 minutes. At the start of the anodic treatment, the electrolyte is at room temperature.(and may increase during the course of the treatment). The particular conditions necessary to secure a reduction in interfacial resistance while maintaining the corrosion resistance properties of the alloy substantially unchanged or enhancing the same may be determined experimentally.

The workpiece is removed and rinsed in deionised water or deionised water made slightly alkaline to remove excess acid, and dried, e.g. in air or by passing a warm air current over the workpiece. The workpiece is then installed as a bipolar plate, separator plate, flow field plate and/or a current collecting plate or screen in the electrochemical cell, e.g. a fuel cell.

Optimised conditions appropriate for anodic treatment of the stainless steel or other alloy in order to reduce interfacial resistance may be established for a given electrolyte and temperature by configuring the sample of the alloy to be treated as the anode in a bath of electrolyte, establishing a potential difference between the anode and a counter electrode (as cathode) so as to pass a dc current of substantially constant current density through the electrolyte between the anode and electrode and using a range of current densities and treatment times. From measurements of the interfacial resistance, the corrosion potential Ecorr and corrosion current Icorr, a suitable operating regime can be determined. In practice, a suitable current density can be established by conducting experiments to determine current densities at which the interfacial resistance (as measured using the technique described above) is significantly reduced. For 316 stainless steel for instance, we have found that a marked reduction in interfacial resistance can be achieved using current densities of 20 mA.cm⁻² and upwards. For efficient energy usage, it is of course desirable to carry out the treatment at as low a current density as can be achieved while securing a significant reduction in interfacial resistance.

For a given electrolyte and temperature, a suitable treatment time may be established by reference to graphical representations such as that illustrated in FIG. 3 which illustrates treatment time against Ecorr and Icorr for treatment of 316 stainless steel carried out at room temperature using a current density of 25 ma.cm⁻² and an electrolyte comprising a 0.5M solution of sulphuric acid. The data for the curves in FIG. 3 corresponds to that tabulated in Table 1 below in which the samples subjected to a current density of 25 mA.cm⁻² are identified by SS316(25).

Table 1 also includes measurements for the following samples of the same stainless steel:

SS316(U)—an untreated sample;

SS316(UG)—a sample which has been grit-blasted using 60/80 alumina but otherwise untreated;

SS316(TG)—a sample which has been grit-blasted using 60/80 alumina and has also been subjected to a current density of the specified magnitude and time;

SS316(100)—a sample which has been subjected to a current density of 100 mA.cm⁻² for 20 minutes.

Ecorr and Icorr were determined by a DC polarisation technique using the following procedure:

Polarisation was carried out in an EG&G (Elmer Perkin) flat cell containing 1N (0.5 mol) H₂SO₄ electrolyte and equipped with a SCE reference electrode and Pt/Rh counter electrode. With the working electrode in place, the cell temperature was set at 60° C. and gently sparged with nitrogen gas and allowed to equilibriate for at least 15 minutes. The voltage drop between the working and counter electrode (open circuit potential) was measured every few minutes until the potential stabilises (±2 mV between successive readings). Potential scanning was effected from −0.5 to 1.0 V vs. SCE at a sweep rate of 0.1 mV.s⁻¹. From the data obtained, a plot of log current density vs. potential, commonly referred to as a Tafel plot, yields the well-known “spiked” polarisation curve, the centre of the spike being the location at which the anodic and cathodic curves meet. This point is treated as the corrosion potential Ecorr. By extrapolation along each part of the curve at a potential not more than 30 mV either side of Ecorr, a value for Icorr can be determined from the point of intersection of the tangents—see Principles and Prevention of Corrosion by Denny A Jones, 2nd Edition, published by Prentice Hall, Page 95 for details of the determination of Icorr.

TABLE 1
Electrolyte: 0.5M sulphuric acid aqueous solution

| | Current | | | | Log |
|---|---|---|---|---|---|
| | Density | Time | RI | Ecorr | [Icorr] |
| Sample | (mA.cm⁻²) | (mins) | (mΩ.cm²⁾ | (mV vs. SCE) | (A.cm⁻²) |
| SS316 | 25 | 1 | 13 | −0.2710 | −6.032 |
| (25) | | | | | |
| SS316 | 25 | 2 | 12 | −0.0277 | −6.458 |
| (25) | | | | | |
| SS316 | 25 | 4 | 13 | 0.0342 | −6.4884 |
| (25) | | | | | |
| SS316 | 25 | 5 | 12 | 0.0685 | −6.2735 |
| (25) | | | | | |
| SS316 | 25 | 6 | 15 | 0.1303 | −6.3196 |
| (25) | | | | | |
| SS316 | 25 | 8 | 14 | −0.1598 | −5.9433 |
| (25) | | | | | |
| SS316 | 25 | 10 | 13 | −0.3102 | −5.7863 |
| (25) | | | | | |
| SS316 | 25 | 30 | 12 | −0.2379 | −5.855 |
| (25) | | | | | |
| SS316 | 25 | 60 | 10 | −0.2674 | −5.7149 |
| (25) | | | | | |
| SS316 | — | — | 64 | −0.316 | −4.946 |
| (U) | | | | | |
| SS316 | — | — | 19 | −3.299 | −5.7149 |
| (UG) | | | | | |
| SS316 | 60 | 25 | 13 | −0.2893 | −6.136 |
| (TG) | | | | | |
| SS316 | 100 | 20 | 10 | NM | |
| (100) | | | | | |

Comparing the SS316(25) and SS316(100) samples with SS316(U), it will be seen that the treatment results in a marked reduction in interfacial resistance R_{I}. Likewise, there is a marked reduction in interfacial resistance R_{I} for the samples which have been grit-blasted but the difference in R_{I} for SS316(UG) and SS316(TG) is only marginal. Also, it will be observed that the R_{I} for SS316(25) when treated for 60 minutes is slightly superior to that for SS316(TG). This suggests that there is nothing to be gained from mechanically roughening the stainless steel surface; however, we do not exclude the possibility of carrying out such roughening from the scope of the present invention.

Also, from Table 1, it will be seen that the interfacial resistance R_{I} measured for SS316(100) is only marginally better than that obtained for the same sample when treated for 5 minutes at 25 mA.cm⁻². However, it will be noted that Ecorr and Icorr values obtained within a window of relatively short treatment times correspond to better corrosion resistance properties than for significantly longer treatment times—cf. SS316(25) when treated for 10 minutes with SS316(25) when treated for between 4 and 6 minutes.

Table 2 gives similar data to that of FIG. 1 for the same stainless steel but using different electrolytes.

TABLE 2

| | | | | | Log |
|---|---|---|---|---|---|
| | Current | | | | [Icorr] |
| | Density | Time | RI | Ecorr | (A. |
| Electrolyte | (mA.cm⁻²) | (mins) | (m Ω.cm²⁾ | (mV vs. SCE) | cm⁻²) |
| H₃PO₄(M) | 100 | 20 | 41 | −0.3162 | −6.0904 |
| HCI(M) | 100 | 20 | 17 | −0.3451 | −4.826 |
| HNO₃(M) | 100 | 20 | 15 | −0.03121 | −6.123 |
| HNO₃(M) | 25 | 2 | 24 | — | — |
| HNO₃(M) | 25 | 4 | 33 | — | — |
| HNO₃(M) | 25 | 6 | 27 | — | — |
| HNO₃(M) | 25 | 8 | 24 | — | — |
| H₃PO₄/ | 100 | 20 | 19 | — | — |
| H₂SO₄ | | | | | |

All electrolytes specified in Table 2 are 1M aqueous solutions of the acid specified. The mixed acid electrolyte (H₃PO₄/H₂SO₄) comprises 1 M aqueous solutions of each acid. Although HCl exhibits a reduction in interfacial resistance, it is not a preferred acid because of corrosion pitting issues.

As previously mentioned, the use of metal bipolar plates in fuel cells is seen as having many advantages over other materials, for instance: thin plates leading to low volume stacks; ease of pressing a flow field into the plate; and low cost metals and alloys are readily available in large quantities. One concern over the use of metals plates however is the issue of corrosion which can result in metal ions from the metal plates blocking active sites in the membrane in a PEM type fuel cell leading to increased cell resistances. Makkus et al (J. Power Sources, 86 (2000) 274) reported that the anode side of the fuel cell (i.e. the hydrogen side) containing metal bipolar plates, gives rise to a greater corrosion of the plate than the cathode (i.e. air) side. Makkus et al also refers to passivation resulting in increased resistance.

To examine the effect of treating stainless steel in accordance with the present invention, operation of a PEM fuel cell was simulated by using an electrolyte of 1 mol dm⁻³ sulphuric acid at 60° C. and polarising a stainless steel test piece at the extremes of the fuel cell operation i.e. 0V vs. SHE for the anode side. The simulation was carried out for treated and untreated test samples of the same 316 stainless steel and was operated for a number of hours. After such operation using each sample, the electrolyte was collected for chemical analysis. The treatment used in preparing the one sample for the simulation involved subjecting the sample to a current density of 25 mA.cm⁻² for 6 minutes in an aqueous electrolyte of 0.5 mole sulphuric acid per dm³ initially at room temperature. The data from the anode side simulation is shown in Table 3 for the untreated sample (Sample 1) and the treated sample (Sample 2).

TABLE 3

| | Treatment | | | | | |
|---|---|---|---|---|---|---|
| | time | Cr | Fe | Mn | Mo | Ni |
| Sample # | (hours) | mg/litre | mg/litre | mg/litre | mg/litre | mg/litre |
| 1 | 50 | 1.8 | 4.3 | 0.14 | 0.3 | 2.1 |
| 2 | 72 | 0.06 | 0.49 | 0.02 | <0.05 | 0.1 |

From Table 3, it will be seen that for the simulated cell using the treated sample there is a substantial reduction in the extent of corrosion, as evidenced by the much lower metal ion presence in the electrolyte.

From Table 3, it will be seen that for the simulated cell using the treated sample there is a substantial reduction in the extent of corrosion, as evidenced by the much lower metal ion presence in the electrolyte. The anodic treatment of the stainless steel usually involves enrichment of the surface layer of the stainless steel in such a way that the iron to chromium content in the surface region of the treated steel (as measured using X ray photoelectron spectroscopy) is reduced. This is illustrated in FIG. 4 for a number of samples of the same 316 stainless steel. Sample 4 represents the bulk composition of the 316 steel in terms of its iron, chromium, nickel and molybdenum constituents. Sample 1 represents a degreased specimen from which it will be seen that the iron content is substantially greater than the chromium content. Sample 2 represents a specimen which has been degreased and surface roughened by grit blasting. In this case, the iron content is even greater compared with the chromium content and is substantially representative of the bulk composition of the stainless steel corresponding to Sample 4. Sample 3 corresponds to a specimen subjected to anodic treatment in accordance with the invention and will be seen to have a surface composition in which the chromium content significant exceeds the iron content.

FIG. 5 illustrates the benefits derived from the use of anodically treated stainless steel plates in a fuel cell. This Figure is a graphical representation comparing the longer term performance of a single cell PEM fuel cell equipped with treated stainless steel plates and one equipped with untreated stainless steel plates (graphs T and U respectively in FIG. 5), the stainless steel plates in both cases being configured as field flow plates located on opposite sides (anode and cathode sides) of the membrane. The treatment applied to the plates involved subjecting them to a current density of 25 mA/cm² in a solution of 0.5 M sulphuric acid electrolyte for 6 minutes in the case of the anode-side plate and for 60 minutes in the case of the cathode-side plate. In the long term test of FIG. 5, the following conditions were used:

hydrogen pressure 3 bar (g)

air pressure 3 bar (g)

hydrogen utilisation 70%

air utilisation 35%

cell temperature 50° C.

humidification 50° C.

compaction force 220 N/cm²

current density 0.7 A/cm²

The comparative long term data for untreated stainless steel comes from D. P. Davies, P. L. Adcock, M. Turpin and S. J. Rowen, J. Power Sources, 86 (2000) 237. From FIG. 5, it can be seen that significant improvement is secured in voltage output by using treated stainless steel plates without sacrificing durability.

The treatment of the stainless steel may be carried out at constant current or at constant voltage. FIG. 6 illustrates interfacial resistance data obtained using the procedure described with reference to FIG. 1 for a sample of the same 316 stainless steel as that referred to in Table 2 but treated in 0.5M sulphuric acid electrolyte for 10 minutes at an applied voltage of 1.8V vs. SCE, i.e. substantially constant voltage against the reference electrode. At an applied pressure of 200 Ncm⁻², the interfacial resistance is approximately 12.5 mΩ.cm² compared with 64 mΩ.cm² for the untreated sample (see SS316(U) in Table 2).

Investigations were also carried out into nickel-containing alloys in which the nickel content exceeded that present in 316L stainless steel, using a 904 stainless steel and Carpenter 20 stainless steel. The 904 stainless steel, more specifically 904L, employed has the general composition: 0.02 max C, 2.0 max Mn, 0.045 max P, 0.035 max S. 1.00 max Si, 23.0-28.0 Ni, 19.0-23.0 Cr, 4.00-5.00 Mo, 1.00-2.00 Cu and balance Fe. The 904 samples used were from a batch having the nominal analysis 25 Ni, 20 Cr, 4.5 Mo, 1.7 Mn, 1.5 Cu, 0.35 Si, 0.02 max C, balance Fe (w/w basis). The Carpenter 20 stainless steel samples had the analysis 32-38 Ni, 19.0-21.0 (e.g. 20) Cr, 3.0-4.0 (e.g. 3.5) Cu, 2.0-3.0 (e.g. 2.5) Mo, 1 max Si, 2.0 max (e.g. 0.8) Mn, 0.035 max S, 0.045 max P, 0.07 max C, balance Fe (w/w basis). Experimental work was carried out in an electrochemical cell using 0.5M sulphuric acid as the electrolyte with 5×5 cm anodes of 904 stainless steel and Carpenter 20 stainless steel at a current density of 25 mA cm⁻² for 6 min. Interfacial/contact resistance measurements were made using the method specified above. The method for determining corrosion potentials and currents was also the same as that specified above except that a potential scan rate of 1 mV s⁻¹ was used.

The interfacial or contact resistance, corrosion potential (Ecorr) and corrosion current (Icorr) of the 904 stainless, after degreasing but prior to anodic treatment, was determined to be 27.5 mΩ cm²@200 N cm⁻², −133 mV vs. SCE and 2.14×10⁻⁶ cm⁻² respectively. After treatment, the interfacial resistance, corrosion potential (Ecorr) and corrosion current (Icorr) of the 904 stainless was determined to be 12.3 mΩcm²@200 N cm−, +56 mV vs. SCE and 3.47×10⁻⁷ A cm⁻² revealing significant improvement in interfacial resistance and corrosion properties.

In the case of Carpenter 20 stainless steel, the interfacial or contact resistance before and after treatment was determined to be respectively 12.4 and 4.3 mΩ cm²@200 N cm⁻².

Although the invention is exemplified above by stainless steel alloys, including those with high nickel contents, improved interfacial resistances have been obtained using other alloys with high nickel contents. This is exemplified by 825, 600 and 020 nickel alloys which have the following compositions (weight percent):

Incoloy 825

0.05 max carbon; 0.5 max silicon; 38-46 nickel; 1.5-3.0 copper; 1 max manganese;

0.03 max sulphur; 19.5-23.5 chromium; 2.5-3.5 molybdenum; 0.6-1.2 titanium;

0.2 max aluminium; and 22 min iron.

Inconel 600

0.15 max carbon; 0.5 max silicon; 72 min nickel; 0.5 max copper; 1 max manganese;

0.015 max sulphur; 14-17 chromium; 6-10 iron.

Incoloy 020

32.0-38.0 nickel; 19.0-21.0 chromium; 3.0-4.0 copper; 2.0-3.0 molybdenum;

carbon 0.07 max; niobium+tantalum 8×C-1.0; 2.0 max manganese; 0.045 max phosphorous; 0.035 max sulphur; 1.0 max silicon; balance iron.

5×5 cm samples of these nickel alloys were subjected to the same experimental conditions as described above in relation to 904 stainless steel. Prior to treatment, the interfacial resistances (at 200 N/cm²) were 88, 8.6 and 36.3 mΩcm² for 825, 600 and 020 respectively. After treatment under the prescribed conditions as stated for 904 stainless steel, the interfacial resistances were found to be 10.2, 4.8 and 10.8 mΩcm² for 825, 600 and 020 respectively.

Experimental work was also carried out involving the deposition of ruthenium on to plates previously treated in the manner described above. The procedure used was as follows:

A sample of the alloy was degreased using acetone and immersed in an electroplating solution containing 0.15% (w/v) ruthenium nitrosyl nitrate in 1 M nitric acid. The electroplating cell was set up with the alloy sample as the cathode and the counter electrode (platinised titanium) as the anode. Current was then passed at a current density of 10 mA.cm⁻², this current was applied for 15 minutes. At the commencement of plating, the solution was at room temperature (however the temperature may tend to increase during the course of the process). After plating, the alloy sample was removed from the bath and rinsed in deionised water and dried. The interfacial resistance was measured in the manner described above.

Using 825 and 020 alloys from the same batch as referred to above, it was found that the interfacial resistance of the sample was further reduced, from 10.2 to 8.0 mΩcm² in the case of 825 and from 10.8 to 8.9 mΩcm² in the case of 020.

Likewise, using 904 stainless steel (but from a different batch to that for which results are given above), the interfacial resistance measurements for the sample prior to any current treatment, after anodising treatment and subsequently after plating with ruthenium were 88, 10.2 and 8.0 mΩcm² respectively.

In a typical production process, a number of sheets or a coil of the alloy, has sets of features introduced into one or both major surfaces (e.g. by etching or pressing) in such a way that each set of the features serve as flow distribution channels for fluids in an electrochemical cell assembly such as a fuel cell stack. The fluids may be (but are not limited to) hydrogen, air, oxygen, water and/or methanol. An example of such a flow pattern is shown in FIG. 7 to be described below. Once the sheet has been treated in accordance with the invention, it can be cut into smaller pieces each forming a plate provided with a set of fluid flow channels on one or each major face, each plate being dimensioned and configured for use in the fuel cell. In accordance with the invention, the sheet alloy material is treated in such a way as to enhance the surface conductivity, preferably without reducing the corrosion resistance and, in some cases, increasing the corrosion resistance of the metal.

The treatment process usually comprises the following steps:

1. The sheet to be treated is first ‘cleaned’ using a degreasing solvent such as acetone, iso-propanol, trichloroethylene, or an alkaline based aqueous system.

2. The sheet is introduced into an aqueous treatment bath containing sulphuric acid, e.g. 0.5 or 1 mol dm⁻³, and optionally a viscosity enhancing agent such as glycol (e.g. PEG) at room temperature or other desired temperature. The treatment bath is equipped with counter electrodes made of suitable material (e.g. titanium coated with iridium dioxide or platinum or stainless steel) which may be in sheet or mesh form and the sheet to be treated is located between the two counter electrodes.

3. Electrical connections are made with both the alloy sheet workpiece and to the counter electrodes and a substantially constant dc current is passed between the counter electrodes and the workpiece. The current density is usually between 1 and 100 mA cm⁻² and is applied for a suitable time (usually between 1 minute to 2 hours), the current density and the time of application being determined experimentally in the light of treating samples of the alloy in the manner described previously.

4. After the current has been applied for the required time, the workpiece is disconnected from the electrical circuitry, removed from the bath and excess acid removed for example by suspending the workpiece over the bath for a time to allow excess acid to drain from the surface into the bath.

5. The treated sheet is then transported to a rinse bath containing deionised water, or deionised water made slightly alkaline with sodium carbonate or sodium hydroxide and after rinsing the sheet is dried in a clean environment. Drying may be performed by natural evaporation or by circulation of air at room or elevated temperature.

6. The dried sheet is cut into smaller plates compatible in size with the dimensions and configuration of the fuel stack into which the plates are to be incorporated as flow field plates and/or bipolar plates for instance.

In an alternative method, instead of dividing the alloy sheet into the individual plates after the treatment process, after being formed with the sets of fluid flow channel features, the sheet may instead initially be separated (e.g. by cutting or etching) into plates of suitable dimensions and configuration for incorporation in the electrochemical cell. The individual plates so formed can then be individually treated in accordance with steps 1 to 5 above.

In another variation, the opposite faces of the alloy sheet or individual plates may be subjected to the treatment to differing extents. For example, each face may be treated with regard to the conditions to which it will be exposed in operation of the electrochemical cell. For example, in the case of a bipolar plate for a fuel cell, one face might be exposed to a fluid comprising hydrogen or methanol (the anode side) and the opposite face may be exposed to a fluid comprising oxygen (the cathode side). By treating the two faces differently, e.g. for different lengths of time, each face may be optimised according to the conditions that it will be exposed to in operation of the fuel cell. Thus, the above process may be modified at step 4 by terminating current flow between one face and the associated counter electrode after a first predetermined time interval appropriate for that face (e.g. the hydrogen or anode side). At that point, that side is disconnected and isolated whilst current flow between the opposite face and its associated counter electrode is continued until lapse of a second predetermined time interval.

Referring now to FIG. 7, one application of the present invention is in the production of a fuel cell stack comprising ion-permeable membranes 31 and 32 which have cathode electrodes 33 and 34 respectively and anode electrodes (not shown), bonded to each of their major surfaces. Each membrane 31, 32 and its associated anode and cathode forms a fuel cell unit. A bipolar separator plate 35, provided with surface features 36, is disposed between ion-permeable membranes 31 and 32 in contact with the electrode surfaces thereof. Terminal plates 37 and 38, provided with tabs 39 and 40 for delivering electric current generated in the cell stack to an external circuit, are disposed adjacent membranes 31 and 32 respectively. In the illustrated embodiment, only one bipolar separator plate 35 is shown. In practice, there will usually be a plurality of bipolar separator plates each associated with adjacent pairs of fuel cell units.

In the stack, membrane 31 is held firmly between terminal plate 37 and bipolar plate 35 so as to form an oxidant gas chamber 41 and a fuel gas chamber 42. In like manner, membrane 32 is held firmly between terminal plate 38 and bipolar plate 35 so as to form an oxidant gas chamber 43 and a fuel gas chamber 44. Hydrogen fuel is supplied to the anodes in the fuel gas chambers 42 and 44 via fuel gas inlet conduit 45 and by-products removed via conduit 46. Oxidant gas is supplied to cathodes 33 and 34 in the oxidant gas chambers 41 and 43 via oxidant gas inlet conduit 47 and by-products removed via conduit 48. Openings 49 and 50 located in opposite corners of membranes 31 and 32 are aligned with hydrogen gas inlet and outlet conduits 45 and 46 and with openings 51 and 52 in bipolar plate 35 to facilitate passage of hydrogen fuel gas into the fuel chambers 42 and 44 and to remove by-products therefrom.

Openings, not shown, and openings 53 located in opposite corners of membranes 31 and 32 are aligned with oxidant inlet and outlet conduits 47 and 48 and with opening 54 and another not shown in bipolar plate 35 to facilitate passage of oxidant gas into the oxidant chambers 41 and 43 and to remove by-products therefrom.

End plates 37 and 38, membranes 31 and 32 and bipolar plate 35 are each provided with a plurality of openings 55 through which assembly tie-rods 56 (one only of which is illustrated in part) pass and engage with nuts 56A so that the fuel cell units and bipolar separator plates are clamped between the end plates 37 and 38. Though not illustrated, sealing gaskets will be interleaved with the membrane carrying plates 31 and 32, the bipolar plates 35 and the end plates 37 and 38 to seal the active interior of the fuel cell stack.

The end plates 37, 38 and/or the bipolar plate 35 are made of metal alloy which has been treated in accordance with the process of the invention so that the interfacial resistance between these plates and the adjacent membranes 31 is significantly reduced. In addition, the conduits and also the tabs 39 and 40 may be made of alloy treated in this way. In the case of the end plates 37, 38 only those faces which are presented towards the interior of the fuel cell stack need be treated in practice. However, for simplicity of treatment, the entire surface of the end plates may be so treated, including the borders which are not actually directly exposed to the interior of the fuel cell stack, and hence the strongly reducing/oxidising and high temperature conditions prevailing during operation of the fuel cell stack.

Although not shown, the stack is desirably provided with cooling means for dissipating at least part of the heat generated during operation. Such cooling means may be implemented by adapting one or more of the separator plates or inclusion of suitable elements within the stack so as to incorporate coolant passageways which are in heat exchange relation with the active interior of the fuel cell stack and through which a coolant fluid such as water or air can be passed, the interiors of the fluid coolant passageways being isolated from the interior of the fuel cell stack.

In a further embodiment of the present invention, a layer of diffusion material which is electrically conducting and porous, for example a carbon-coated paper or a graphite-impregnated polymer film, is disposed in the oxidant gas chambers 41 and 43 and/or in the fuel gas chambers 42 and 44. For example, the layer of diffusion material may be disposed between bipolar plate 35 and the adjacent electrode surfaces of membranes 31 and 32 and/or between the terminal plates 37 and 38 and the adjacent electrode surfaces of membranes 31 and 32.

What is claimed is:

1. A method of manufacturing an electrochemical cell assembly in which at least one component which is exposed to the chemical environment during operation of the cell comprises a metal alloy, said method comprising treating a surface of the alloy, prior to incorporation in the assembly, with an electrical current while contacted by an electrolyte, the alloy being a stainless steel or an alloy containing nickel in excess of that present in 316L stainless steel and incorporating the treated component in the cell assembly.

2. A method of manufacturing an electrochemical cell assembly in which at least one component which is exposed to the chemical environment during operation of the cell comprises a metal alloy, said method comprising treating a surface of the alloy, prior to incorporation in the assembly, with an electrical current while contacted by an electrolyte, the alloy being a corrosion resistant alloy containing nickel and chromium, and incorporating the treated component in the cell assembly.

3. A method as claimed in claim 2 in which the nickel content exceeds the chromium content.

4. A method as claimed in claim 2 in which the alloy contains iron.

5. A method as claimed in claim 4 in which the iron content exceeds the combined nickel and chromium content.

6. A method as claimed in claim 4 in which the combined nickel and chromium content exceeds the iron content.

7. A method as claimed in claim 2 in which nickel is present in an amount in excess of 14% by weight.

8. A method as claimed in claim 2 in which nickel is present in an amount in excess of 15% by weight.

9. A method as claimed in claim 2 in which nickel is present in an amount of at least 17% by weight.

10. A method as claimed in claim 2 in which nickel is present in an amount of at least 20% by weight.

11. A method as claimed in claim 2 in which nickel is the major component of the alloy.

12. A method as claimed in claim 4 in which the treatment is effective to reduce the ratio of iron to chromium content within the surface region of the alloy compared with the iron to chromium ratio prevailing prior to such treatment.

13. A method as claimed in claim 1 in which the current density to which the stainless steel surface is subjected during at least a major part of said treatment is substantially constant.

14. A method as claimed in claim 1 in which the alloy is an austentic stainless steel.

15. A method as claimed in claim 1 in which the alloy comprises one selected from the group comprising 316, 316L, 904, 904L and Carpenter 20 stainless steel.

16. A method as claimed in claim 1 in which the alloy is one selected from the group comprising Incoloy 825, Incoloy 020 and Inconel 600.

17. A method as claimed in claim 1 in which the electrolyte includes at least one acid selected from the group comprising sulphuric acid, a halogenic acid, nitric acid, chromic acid, oxalic acid and phosphoric acid.

18. A method as claimed in claim 1 in which the electrolyte includes sulphuric acid as the only or the main acidic component.

19. A method as claimed in claim 1 in which the interfacial resistance of the alloy is reduced by a factor of at least 5% compared with the interfacial resistance prevailing prior to said treatment.

20. A method as claimed in claim 1 in which the interfacial resistance of the stainless steel is reduced by a factor of at least 10% compared with the interfacial resistance prevailing prior to said treatment.

21. A method as claimed in claim 1 in which the interfacial resistance of the stainless steel is reduced by a factor of at least 15% compared with the interfacial resistance prevailing prior to said treatment.

22. A method as claimed in claim 1 in which the interfacial resistance of the stainless steel is reduced by a factor of at least 25% compared with the interfacial resistance prevailing prior to said treatment.

23. A method as claimed in claim 1 in which the interfacial resistance of the stainless steel is reduced by a factor of at least 40% compared with the interfacial resistance prevailing prior to said treatment.

24. A method as claimed in claim 1 in which following said treatment and prior to incorporation in the electrochemical cell assembly, one or more treated surfaces of the alloy is coated with an electrically conductivity enhancing material.

25. A method as claimed in claim 1 in which following said treatment and prior to incorporation in the electrochemical cell assembly, one or more treated surfaces of the alloy is coated with a material selected from the group comprising titanium nitride, chromium nitride, ruthenium, ruthenium oxide and an electrocatalytically active material other than ruthenium or ruthenium oxide.

26. A method as claimed in claim 1, the assembly comprising bipolar plates, separator plates, flow field plates and/or current collecting plates or screens, at least one of which comprises said alloy treated as aforesaid.

27. A method as claimed in claim 1 in which two or more surfaces of the alloy are so treated.

28. A method as claimed in claim 27 in which the same treatment is applied at least to each major surface of the alloy.

29. A method as claimed in claim 27 in which the treatment applied to one surface of the alloy is different from that applied to one or more other surfaces of the alloy.

30. A method as claimed in claim 1 in which the cell assembly comprises two or more alloy components treated as aforesaid.

31. A method as claimed in claim 1, the alloy being one in which nickel, chromium and iron are the major alloying components.

32. A method as claimed in claim 1 in which the treatment is carried out using a current density in the range from about 1 to about 100 mA.cm⁻².

33. A method as claimed in claim 32 in which the treatment is carried out using a current density of at least about 20 mA.cm⁻².

34. A method as claimed in claim 32 in which the treatment is carried out using a current density of up to about 50 mA.cm⁻².

35. A method as claimed in claim 1 in which the treatment is carried out for a time interval of between 0.5 and 180 minutes.

36. A method as claimed in claim 35 in which the treatment is carried out for a time interval of at least about 1 minute.

37. A method as claimed in claim 35 in which the treatment is carried out for a time interval of up to about 60 minutes.

38. A method as claimed in claim 35 in which the treatment is carried out for a time interval of between about 3 and about 7 minutes.

39. A method as claimed in claim 1 in which the treatment is carried out while the alloy is in the form of a sheet and in which the treated sheet is subsequently divided to form a number of plates for incorporation in one or more electrochemical cell assemblies.

40. A method as claimed in claim 1 in which the alloy is initially in the form of a sheet and in which the sheet is divided to form a number of plates before the treatment is applied to the individual plates.
